(19) United States
(12) Patent Application Publication
(10) Pub. No.: US 2005/0087074 A1
(43) Pub. Date: Apr. 28, 2005

(54) Coffee maker

(76) Inventor: Kuan-Chih Lin, Tainan Hsien (TW)

Correspondence Address: Leong C. Lei;PMB#1008, 1867 Ygnacio Valley Rd., Walnut Creek, CA, 94598-3214, US

(21) Appl. No.: 10/693,866

(22) Filed: Oct. 28, 2003

(51) Int. Cl. A01J 11/00

(52) U.S. Cl. 99/279

(57) ABSTRACT

An improved structure of a coffee maker that allows consistent coffee making starting from grinding the coffee beans is essentially comprised of a main unit; at the upper end of the main unit extending an arm; and at the lower end, a heating panel containing a heater; an opening being provided on the top of the arm to be inserted with a funnel and provided with a grinder right beneath the opening; a basket with an outlet facing downward being provided at the end of the arm; a vacuum coffee maker including an upper and a lower bowls being placed on the heating panel; a temperature sensor being provided on the lower part of the main unit to rest on the surface of the lower bowl; coffee beans falling through the funnel being ground by the grinder before falling through the basket into the upper bowl; water in the lower bowl being boiled to make coffee depending on the amount and flavor as preset.

### BACKGROUND OF THE INVENTION

(a) Technical Field of the Invention

The present invention is related to an improved structure of a coffee maker, and more particularly to one that allow the consistent making from grinding coffee beans to finished coffee.

(b) Description of the Prior Art

Coffee has been also becoming popular in the oriental countries. Well ground coffee grains of various brands are generally available to facilitate coffee making by the consumer. To gourmet coffee drinkers, the coffee made on site is the best coffee indeed. However, making coffee involves a precise control of the fire temperature, and that certainly is not anyone could do it right. Not only the grinding and making must be separately processed, but also it takes manual control over the size of the ground coffee beans, water amount, time of making and fire temperature. Taking the vacuum coffee maker as illustrated in FIG. 1 of the accompanying drawings for example, a lower bowl 2 is placed on the top of a frame 1 and a alcohol burner is placed below the lower bowl 2. An upper bowl is inserted to the top of the lower bowl 2. The upper bowl relates to a hollow transparent body and a stem 41 extends from the bottom of the upper bowl 4 into the lower bowl 2 and a strainer 42 is provided at the bottom of the upper bowl 4. To make coffee, a proper amount of water is poured into the lower bowl 2 and the alcohol burner is ignited to heat the water in the lower bowl 2. Once the water in the lower bowl 2 is boiling, the upper bowl 4 containing ground coffee beans is inserted to the lower bowl 2 with both openings of the upper bowl 4 and the lower bowl 2 practically in sealed status, so that the heat inside the lower bowl 2 forces the hot water to rise up through the stem 41 into the upper bowl 4, thus to inject boiling water into the ground coffee beans. The alcohol burner 3 is moved away at a proper time to allow the temperature inside the lower bowl 2 to suddenly drop so to reduce the pressure inside the lower bowl 2 and to permit the coffee flowing from the upper bowl 4 into the lower bowl 2 while the coffee residuals are retained at the upper end surface of the upper bowl 4 by the strainer 42. The grinding of coffee beans before hand, the control of water amount and making time all requires some experience to make a cup of good coffee. This prevents the consumer in average to make own coffee. Furthermore, once coffee beans are ground, its original flavor could get easily lost due to ambient humidity. How to make the grinding of coffee beans and making coffee a consistent process while allowing automatic control of water amount and boiling time to make a cup of good taste and fragrant coffee is the bottleneck the industry desperately seeks for a breakthrough.

### SUMMARY OF THE INVENTION

The primary purpose of the present invention is to provide an improved structure of a coffee maker that allows a consistent process of making coffee from grinding the coffee beans until the coffee is made. To achieve the purpose, a heating panel containing a heater is extended from the lower end of the main unit of the coffee maker and an arm is extended from the upper end of the main unit. An opening is provided on the top end of the arm and is inserted with a funnel. A grinder is built in the arm below the funnel and a basket with an outlet facing down is extended from the end of the arm while a vacuum coffee maker is placed on the heating panel. Once the coffee maker is turned on, the grinder grinds coffee beans falling through the funnel into coffee grains. Coffee grains then fall through the basket into the upper bowl of the vacuum coffee maker for the heater to heat up the water in the lower bowl to make the coffee at the amount and flavor of heavy/medium/light as preset.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side view of a vacuum coffee maker of the prior art.

FIG. 2 is a perspective view of a preferred embodiment of the present invention.

FIG. 3 is an exploded view showing a local part of the preferred embodiment of the present invention.

FIG. 4 is a schematic view showing that the preferred embodiment of the present invention is in making coffee.

FIG. 5 is another schematic view showing that the preferred embodiment of the present invention is in making coffee.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

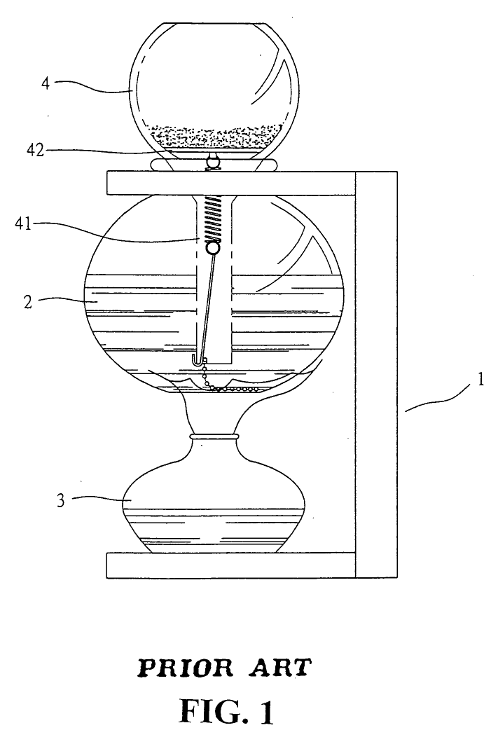

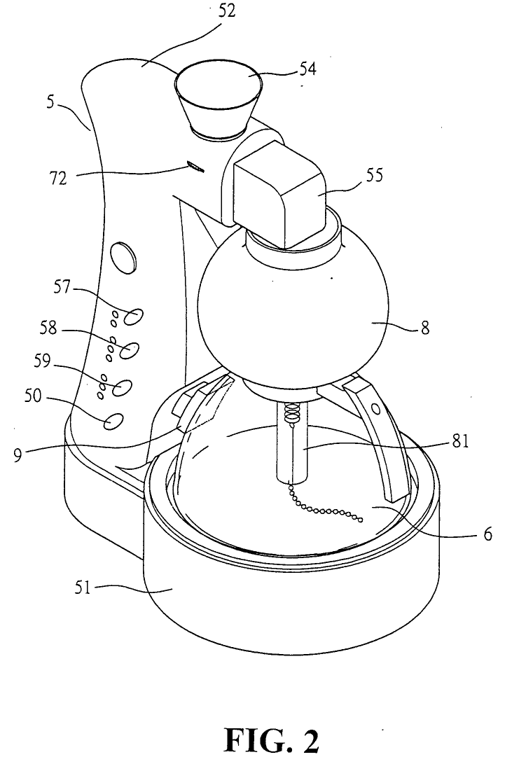

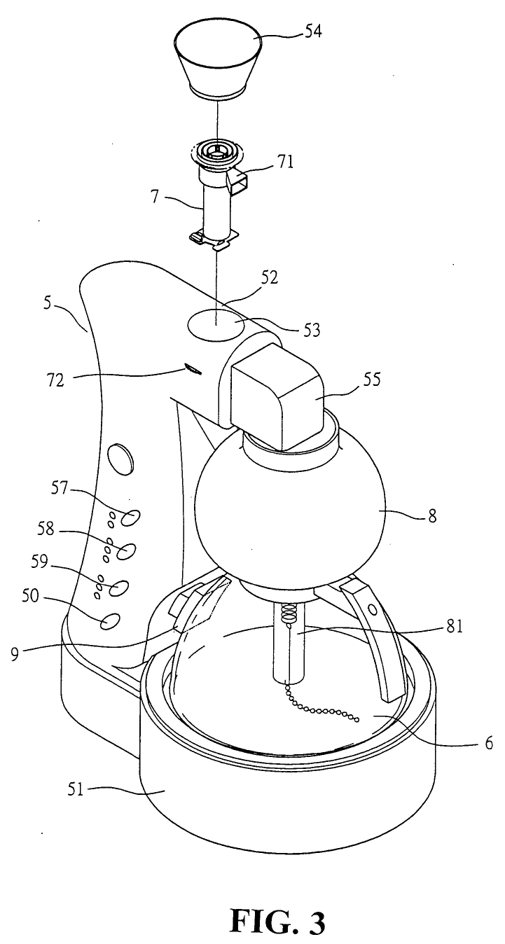

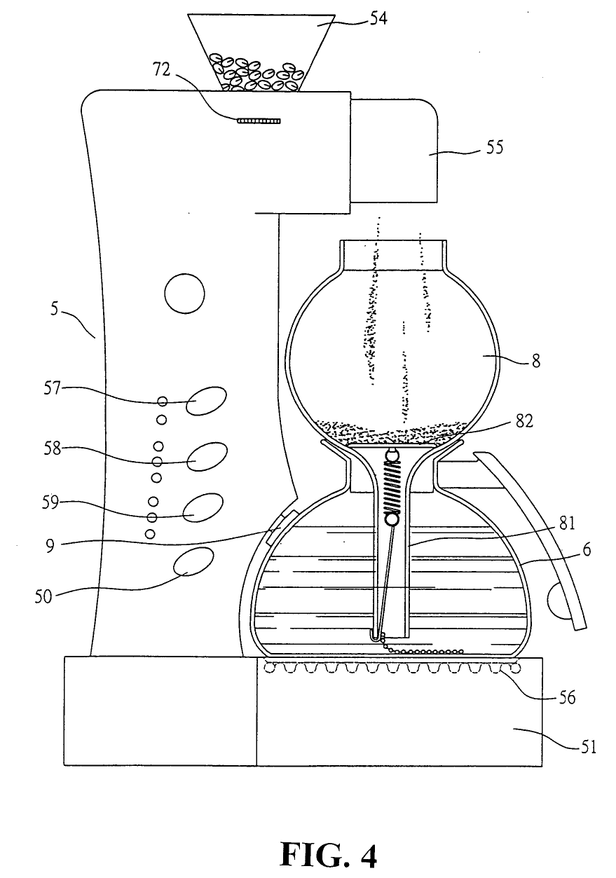

Referring to FIGS. 1 and 2, a preferred embodiment of the present invention is essentially comprised of a main unit 5 having extended at its below a heating plate 51 whereon a vacuum coffee maker 6 while having on it top surface extended an arm 42 provided with an opening 53. A grinder 7 is placed inside the arm 52 at where below the opening 53, an outlet 71 is provided at the tip of the grinder 7, and a funnel 54 is inserted to the opening 53. An adjustment ring 72 is provided on one side of the arm 52 at where in relation to the grinder 7 for adjusting the size of the ground coffee grains. A basket 55 extends downward from the front end of the arm 52. An upper bowl 8 is inserted to the lower bowl 6 and a stem 81 extends from the bottom of the upper bowl into the lower bowl 6. As illustrated in FIG. 4, a strainer 82 is placed at the bottom inside the upper bowl 8. A temperature sensor 9 is provided at the lower part of the main unit 5 to merely rest on the surface of the lower bowl 6. A heater 56 is provided inside the heating plate 51. On the longitudinal surface of the main unit 5 is provided with a cup load selection key 57, a heavy/medium/light selection key 58, a function selection key 59 and an on/off key 50 in sequence from top.

The cup load selection key 57, in the preferred embodiment, the range of selection falls between two through six cups depending how strong the coffee one is preferred.

Upon having selected the cup load, heavy, medium or light is selected with the same cup load by pressing the heavy/medium/light selection key 59.

The function selection key 59 is available for three options, respectively in sequence, Grinding, Boiling and Warming. Wherein, if Grinding is selected, the coffee maker performs all three functions in sequence; if Boiling is selected, the coffee maker performs two functions in sequence of Boiling and Warming; and if Warming is selected, the coffee maker performs only the function of Warming.

Upon having completed the selection of the function desires, the On/Off key 50 is pressed to start the programmed function (s). To interrupt the process in the course of performing the programmed function, press the On/Off key once again to return the coffee maker to its stand-by status.

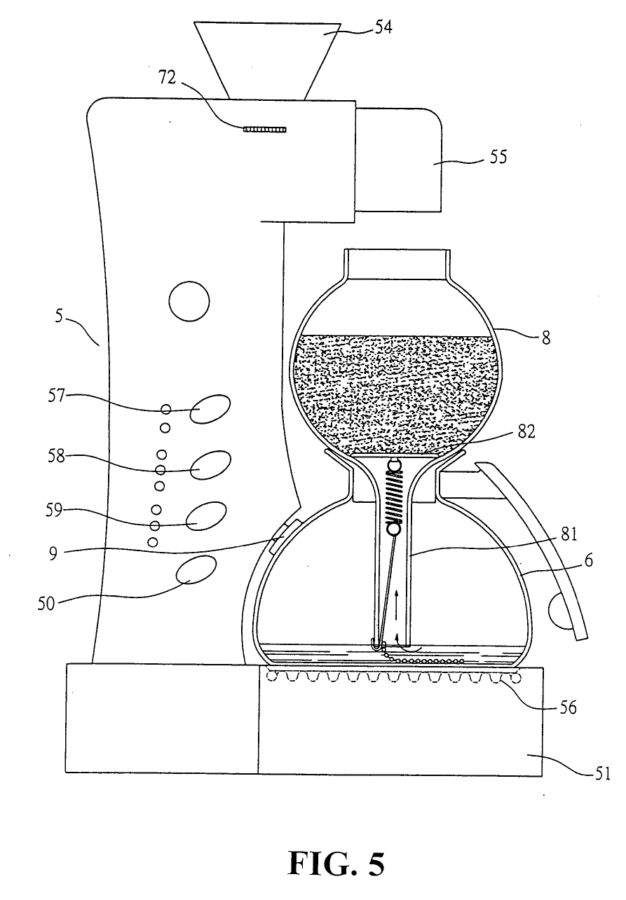

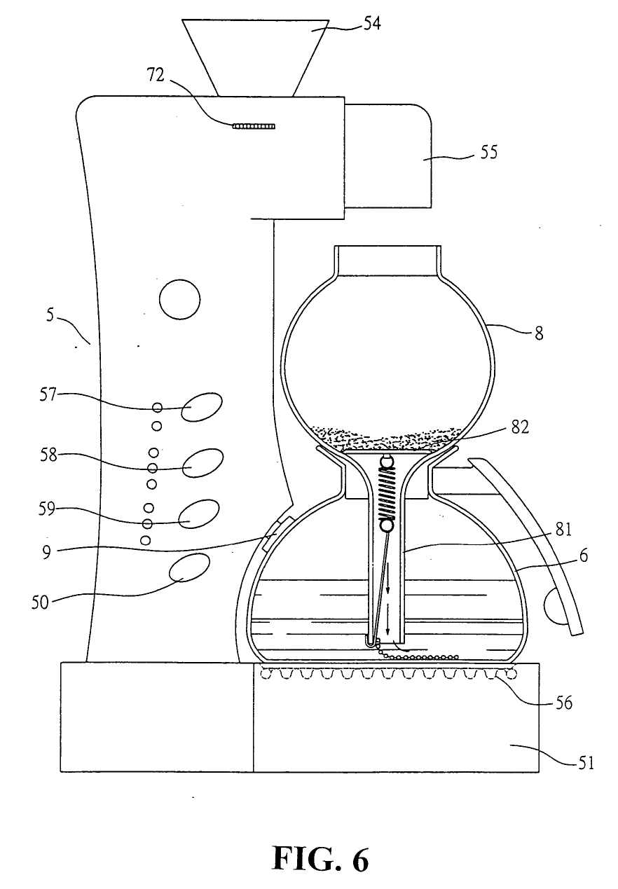

A microprocessor is used in the present invention to control the process of each step. The control relates to an electronic technology generally known to those who are familiar with the art, therefore will not be elaborated herein. Now referring to FIGS. 4 and 5, coffee beans are poured into the funnel 54 then fill the water into the lower bowl 6. Completing the selection by pressing all the selection keys one by one. The grinder 7 grinds those coffee beans into grains in size as desired. By eccentric force, coffee grains are thrown from the outlet 71 into the basket 55 and fall into the upper bowl through the basket. Meanwhile, the heater 56 inside the heating panel 51 starts to heat up the lower bowl 6. Once the water in the lower bowl 6 is boiling, the boiling water rises up by riding the hot pressure into the upper bowl 8. The heater is automatically stopped heating when the temperature sensor detects the preset temperature preset for the surface of the lower bowl 6. Once the heater 56 stops heating the lower bowl 6, the temperature in the lower bowl 6 fast drops, and the pressure also drops to allow the water in the upper bowl 8 containing coffee flow down into the lower bowl and the mode of Warming is also started to complete the automated coffee making. With the automated control by the microprocessor built in the present invention, grinding, boiling and time control is fully automated while depending on individual drinker's preference, the flavor of the coffee can be adjusted for heavier or lighter for convenience in practical use. Meanwhile, the amount of coffee beans is determined by the cup load desires, there will be no deteriorated flavor of the coffee due to excessive residual of coffee grains so warrant a cup of fragrant coffee ready for drinking at any time.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. An improved structure of a coffee maker is comprised of a main unit; a heating penal extending from the lower end of the main unit; a vacuum coffee maker including an upper bowl and a lower bowl being placed on the heating panel; a temperature sensor being provided at the lower end resting on the surface of a lower bowl of the coffee maker; the heating panel containing a heater; an arm extending from the upper end of the main unit; an opening being provided to the arm; a funnel being inserted to the opening; a grander being provided in the arm at where below the opening; an outlet being provided at the front end of the grinder; a basket having an outlet facing downward being extended from the front end of the arm; a stem being extending from the bottom of the upper bowl into the lower bowl; a strainer being provided at the bottom of the upper bowl; and multiple functional keys being provided in sequence on the longitudinal surface of the main unit.

2. An improved structure of a coffee maker as claimed in claim 1, wherein, an adjustment ring is provided on the arm at where in relation to the grinder to adjust the size of the ground coffee grains.
